(19) United States
(12) Patent Application Publication
(10) Pub. No.: US 2017/0125880 A1
(43) Pub. Date: May 4, 2017

(54) ANTENNA DEVICE AND RFID TAG

(71) Applicant: FUJITSU LIMITED, Kawasaki-shi (JP)

(72) Inventors: Yasumitsu BAN, Yokohama (JP); Manabu Kai, Yokohama (JP)

(73) Assignee: FUJITSU LIMITED, Kawasaki-shi (JP)

(21) Appl. No.: 15/299,437

(22) Filed: Oct. 20, 2016

(30) Foreign Application Priority Data
Nov. 2, 2015 (JP) 2015-215996

(51) Int. Cl. H01Q 1/22; H01Q 1/36; H01Q 1/48; G06K 7/10

(52) U.S. Cl. CPC H01Q 1/2225; G06K 7/10316; H01Q 1/36; H01Q 1/48

(57) ABSTRACT

An antenna device includes a board including an attachment face for attaching to an object, a rectangular plane antenna element arraying an layer of the board other than the attachment face, including two terminals, and having a longitudinal direction, and a planar parasitic element arraying so as to be adjacent to the plane antenna element in the longitudinal direction.

### CROSS-REFERENCE TO RELATED APPLICATION

This application is based upon and claims the benefit of priority of the prior Japanese Patent Application No. 2015-215996, filed on Nov. 2, 2015, the entire contents of which are incorporated herein by reference.

### FIELD

The embodiment discussed herein is related to antenna devices and radio frequency identification (RFID) tags.

### BACKGROUND

A conventional antenna device includes a substrate, a ground conductor provided on a back face of the substrate, a radiation conductor having a cutout and provided on a front face of the substrate, a ground terminal provided in the cutout of the radiation conductor, a conductor connected to the ground conductor and the ground terminal, and a feeding terminal connected to the radiation conductor, where the ground terminal and the feeding terminal are connected to an integrated circuit (IC) chip.

International Publication Pamphlet No. WO 2006/049068 is an example of related art.

Such a conventional antenna device includes a ground conductor provided on the back face of the substrate so as to avoid getting affected by a metal plate when attached onto the metal plate. Thus, communication characteristics may largely vary, depending on whether the antenna device is attached to or not attached to a metal plate.

When the communication characteristics largely vary, depending on whether it is attached to or not attached to a metal plate, a communication distance may largely vary and as a result, stable communication may fail to be performed.

### SUMMARY

According to an aspect of the invention, an apparatus includes a board including an attachment face for attaching to an object, a rectangular plane antenna element arraying an layer of the board other than the attachment face, including two terminals, and having a longitudinal direction, and a planar parasitic element arraying so as to be adjacent to the plane antenna element in the longitudinal direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a radio frequency identification (RFID) tag according to an embodiment;

FIG. 2 illustrates an antenna device according to the embodiment;

FIG. 3 illustrates the directions of an electric field caused when the RFID tag is present in the air;

FIG. 4 illustrates simulation results of determining the electric field vectors of the RFID tag;

FIG. 5 illustrates simulation results of determining the electric field vectors of the RFID tag;

FIG. 6 illustrates the frequency characteristics of the communication distance of the RFID tag;

FIG. 7 illustrates the frequency characteristics of the communication distance of an RFID tag for comparison;

FIGS. 8A to 8C illustrate examples of the dimensions of a simulation model of the antenna device;

FIG. 9 illustrates examples of the dimensions of a simulation model of a metal plate;

FIG. 10 illustrates the characteristics of the antenna device with respect to the communication distance and a total width of resonance frequency;

FIG. 11 illustrates the frequency characteristics of the communication distance of the antenna device in a case where the total thickness is set to 10 mm;

FIG. 12 illustrates an antenna device according to a variation of the embodiment;

FIG. 13 illustrates an antenna device according to a variation of the embodiment;

FIG. 14 illustrates the frequency characteristics of the communication distance of the antenna device in FIG. 12;

FIG. 15 illustrates the frequency characteristics of the communication distance of the antenna device in FIG. 13;

FIG. 16 illustrates an antenna device according to a variation of the embodiment;

FIG. 17 illustrates the frequency characteristics of the communication distance of the antenna device in FIG. 16;

FIG. 18 illustrates an antenna device according to a variation of the embodiment;

FIG. 19 illustrates the frequency characteristics of the communication distance of the antenna device in FIG. 18;

FIG. 20 illustrates a variation of the embodiment;

FIG. 21 illustrates a variation of the embodiment;

FIG. 22 illustrates a variation of the embodiment;

FIG. 23 illustrates a variation of the embodiment;

FIG. 24 illustrates the frequency characteristics of the communication distance of an antenna device that uses the antenna and the parasitic element illustrated in FIG. 23;

FIG. 25 illustrates a variation of the embodiment;

FIG. 26 illustrates a variation of the embodiment;

FIG. 27 illustrates a variation of the embodiment;

FIG. 28 illustrates a variation of the embodiment;

FIG. 29 illustrates a variation of the embodiment;

FIG. 30 illustrates a variation of the embodiment;

FIG. 31 illustrates a variation of the embodiment; and

FIG. 32 illustrates a variation of the embodiment.

### DESCRIPTION OF EMBODIMENT

An aspect of an embodiment is aimed at providing an antenna device and a radio frequency identification (RFID) tag, which may enable stable communication.

### Embodiment

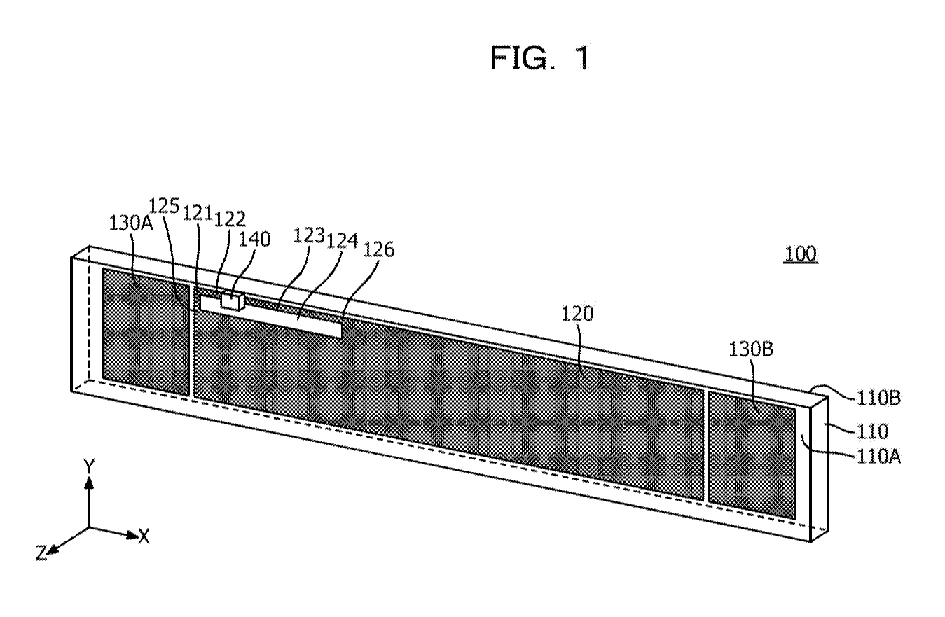

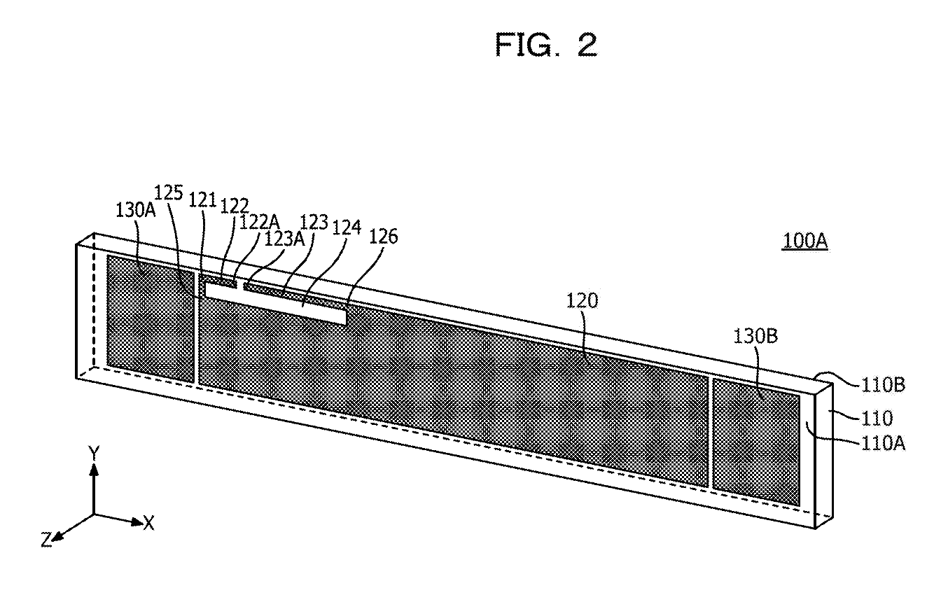

FIG. 1 illustrates an RFID tag 100 according to an embodiment. FIG. 2 illustrates an antenna device 100A according to the embodiment. As illustrated, FIGS. 1 and 2 each define an XYZ coordinate system, which is an example of a Cartesian coordinate system. Hereinafter, a plan view represents viewing an XY plane in the Z-axis direction.

The RFID tag 100 includes a base portion 110, an antenna 120, parasitic elements 130A and 130B, and an integrated circuit (IC) chip 140. The antenna device 100A has a structure obtained by removing the IC chip 140 from the RFID tag 100 illustrated in FIG. 1. That is, the antenna device 100A includes the base portion 110, the antenna 120, and the parasitic elements 130A and 130B.

Hereinafter, a face on the Z-axis positive direction side is referred to as a front face and a face on the Z-axis negative direction side is referred to as a back face. These are definitions for convenience in explanation and constitute no universal denotation of being the front face or the back face.

The base portion 110 is a sheet-like member, which has a longitudinal direction along the X-axis direction and is rectangular in a plan view, and is an example of a board. The base portion 110 includes a front face 110A and a back face 11B. On the front face 110A of the base portion 110, the antenna 120 and the parasitic elements 130A and 130B are arranged, and the IC chip 140 is also mounted.

The back face 110B of the base portion 110 is an attachment face used in attaching the RFID tag 100 to an article. The article may be made of metal or no metal, and may be anything as long as the article allows the RFID tag 100 to be attached to the article.

The base portion 110 is made of for example, silicone rubber and has flexibility. When the base portion 110 is made of silicone rubber, it is difficult to directly form the antenna 120 and the parasitic elements 130A and 130B on the front face 110A of the base portion 110 and thus, a polyethylene terephthalate (PET) film on which the antenna 120 and the parasitic elements 130A and 130B are formed may be attached to the front face 110A of the base portion 110. In FIGS. 1 and 2, the PET film is omitted.

Even when such a PET film on which the antenna 120 and the parasitic elements 130A and 130B are formed is provided on the front face 110A of the base portion 110, the antenna 120 and the parasitic elements 130A and 130B are regarded as being arranged on the front face 110A of the base portion 110.

The material of the base portion 110 is not limited to silicone rubber and the base portion 110 may be a PET film. When the base portion 110 is a PET film, the antenna 120 and the parasitic elements 130A and 130B may be directly formed on the front face 110A of the base portion 110.

The base portion 110 may be no PET film and for example, a polypropylene film or a film made of vinyl chloride is usable for the base portion 110. The base portion 110 may be a flame retardant type 4 (FR-4) printed board.

The antenna 120 is arranged on the front face 110A of the base portion 110. The antenna 120 is made of for example, aluminum foil and in a state of being deposited on the PET film, the whole PET film is arranged on the front face 110A of the base portion 110. The length of the antenna 120 in the longitudinal direction is set so as to be equal to or shorter than a half wavelength at first communication frequency, which is based on the electrical length.

The antenna 120 includes a line 122 shaped like the capital letter L and a straight line 123, which are positioned near a vertex 121 on the X-axis negative direction side and the Y-axis positive direction side. The line 122 and the line 123 are obtained by, between a terminal 122A and a terminal 123A (see FIG. 2), dividing a line shaped like the capital letter L, which is positioned further on the X-axis negative direction side and the Y-axis positive direction side than a slot-like non-formation portion 124 provided near the vertex 121 of the antenna 120.

In the non-formation portion 124, the aluminum foil of the antenna 120 is not formed. The line 122 is a line shaped like the capital letter L, which extends in the Y-axis positive direction from a point 125 positioned further on the Y-axis negative direction side by a predetermined length than the vertex 121 and bends at the vertex 121 toward the X-axis positive direction side. The line 123 is a straight line, which extends in the X-axis negative direction from a point 126 positioned further on the X-axis positive direction side by a predetermined length than the vertex 121.

The terminal 122A and the terminal 123A are positioned at ends of the line 122 and the line 123, respectively. Respective two terminals present on the back face of the IC chip 140 are connected to the terminal 122A and the terminal 123A. The terminals 122A and 123A may be regarded as a pair of feeding points, or one of the terminals 122A and 123A may be regarded as a feeding point and the other may be regarded as a ground point.

The antenna 120 may be made of metal other than aluminum. When the base portion 110 is an FR-4 board, the antenna 120 may be made of foil of metal, such as copper, which is provided on an insulation layer or an internal layer of the FR-4 board.

The parasitic elements 130A and 130B are arranged on the front face 110A of the base portion 110 so as to be adjacent to the antenna 120. The parasitic elements 130A and 130B are positioned on the X-axis negative direction side and the X-axis positive direction side of the antenna 120, respectively, so as to be adjacent to the antenna 120. The clearances between the parasitic element 130A and the antenna 120 and between the parasitic element 130B and the antenna 120 in the X-axis direction are each set to the extent that may cause electromagnetic coupling.

In designing the antenna device 100A, the clearances between the parasitic element 130A and the antenna 120 and between the parasitic element 130B and the antenna 120 are parameters for adjusting the degree of the coupling between the antenna 120 and the parasitic elements 130A and 130B. As the clearances between the antenna 120 and the parasitic element 130A and between the antenna 120 and the parasitic element 130B decrease, the degree of the coupling increases and as the clearances increase, the degree of the coupling decreases.

Similar to the antenna 120, the parasitic elements 130A and 130B are made of for example, aluminum foil and in a state of being deposited on the PET film, the whole PET film is arranged on the front face 110A of the base portion 110.

Similar to the antenna 120, the parasitic elements 130A and 130B may be made of metal other than aluminum. When the base portion 110 is an FR-4 board, the parasitic elements 130A and 130B may be made of foil of metal, such as copper, which is provided on an insulation layer or an internal layer of the FR-4 board. In this case, the parasitic elements 130A and 130B may be arranged on a face different from the face on which the antenna 120 is arranged. For example, the parasitic elements 130A and 130B may be provided on an insulation layer of the FR-4 board and the antenna 120 may be provided on an internal layer thereof, and vice versa.

The IC chip 140 is mounted on the front face 110A of the base portion 110 and is electrically connected to the antenna 120.

On receiving a signal for reading in a radio frequency (RF) band from a reader-writer of the RFID tag 100 through the antenna 120, the IC chip 140 operates with the power of the reception signal and transmits identification information through the antenna 120. Accordingly, the reader-writer enables the identification information on the RFID tag to be read.

Although herein, the base portion 110, the antenna 120, the parasitic elements 130A and 130B, and the IC chip 140 are described as the RFID tag 100, the base portion 110, the antenna 120, the parasitic elements 130A and 130B, and the IC chip 140 may be treated as an inlay.

Although herein, as an example, an embodiment in which the antenna 120 and the parasitic elements 130A and 130B are exposed on the front face 110A of the base portion 110, a base portion similar to the base portion 110 may be attached to the front face 110A so as to cover the antenna 120 and the parasitic elements 130A and 130B.

The base portion similar to the base portion 110 has the same dimensions as those of the base portion 110 in a plan view and is formed of the same material as that of the base portion 110. When this base portion covers the front face 110A of the antenna 120 and the parasitic elements 130A and 130B, the antenna 120 and the parasitic elements 130A and 130B are sandwiched between the base portion 110 and the other base portion.

In such a case, instead of the base portion similar to the base portion 110, a member like a protection sheet, which has a structure different from that of the base portion 110, may protect the front face 110A of the antenna 120 and the parasitic elements 130A and 130B. The protection sheet may be formed of a material similar to that of the base portion 110 or may be formed of a different material.

In the design stage of the RFID tag 100 (the antenna device 100A) described above, for example, the dimensions of each constituent, the degree of the coupling of portions and/or impedance are adjusted so that the communication distance in a case where the RFID tag 100 is not attached to an object formed of metal and the communication distance in a case where the RFID tag 100 is attached to an object formed of metal may be similar to each other. In particular, the degree of the coupling between the antenna 120 and the parasitic element 130A or 130B largely influences the difference between the two communication distances.

When the RFID tag 100 is not attached to an object formed of metal, the RFID tag 100 may be present in the air without being attached to any object or the RFID tag 100 may be attached to an object made of a dielectric. The difference between the two cases is mainly the difference in relative permittivity around the RFID tag 100, and the behaviors of the RFID tag 100, which include communication characteristics, are similar.

Thus, herein, the case where the RFID tag 100 is attached to an object formed of metal and the case where the RFID tag 100 is present in the air are reviewed. The case where the RFID tag 100 is present in the air represents a case where the RFID tag 100 is present in the air without being attached to any object.

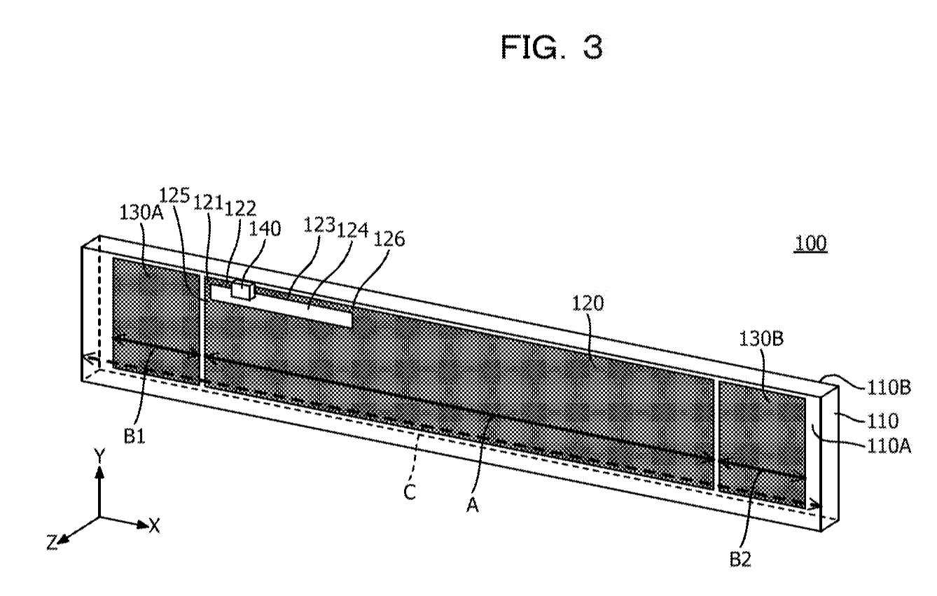

Referring now to FIG. 3, the directions of an electric field caused when the IC chip 140 of the RFID tag 100 operates with the power of a reception signal and transmits identification information through the antenna 120 while the RFID tag 100 is present in the air are described. The reception signal is a signal for reading the RFID tag 100 and is an alternating current (AC) signal of first communication frequency used for designing the longitudinal direction of the antenna 120.

FIG. 3 illustrates the directions of the electric field caused when the RFID tag 100 is present in the air.

When AC power is fed from the IC chip 140 through the terminals 122A and 123A (see FIG. 2) as indicated with arrows A, the antenna 120 causes an electric field, which varies in the X-axis direction. Since the length of the antenna 120 in the longitudinal direction is set so as to be equal to or shorter than a half wavelength of the first communication frequency, which is based on the electrical length, the electric field that varies in the X-axis direction as indicated with the arrows A occurs.

Since the antenna 120 is coupled to the parasitic elements 130A and 130B and the RFID tag 100 is not attached to an object made of metal, the parasitic elements 130A and 130B are fed with power from the antenna 120 and resonance occurs as indicated with arrows B1 and B2.

Consequently, in the antenna 120 and the parasitic elements 130A and 130B, resonance occurs as indicated with arrow C.

As described above, when the RFID tag 100 is present in the air, the antenna 120 is coupled to the parasitic elements 130A and 130B and the effect that is similar to the increase in the apparent area of the antenna 120 is obtainable and accordingly, the gain of the antenna device 100A increases.

As a result, the communication distance of the antenna device 100A may be lengthened and when the RFID tag 100 is present in the air, a sufficient communication distance may be ensured.

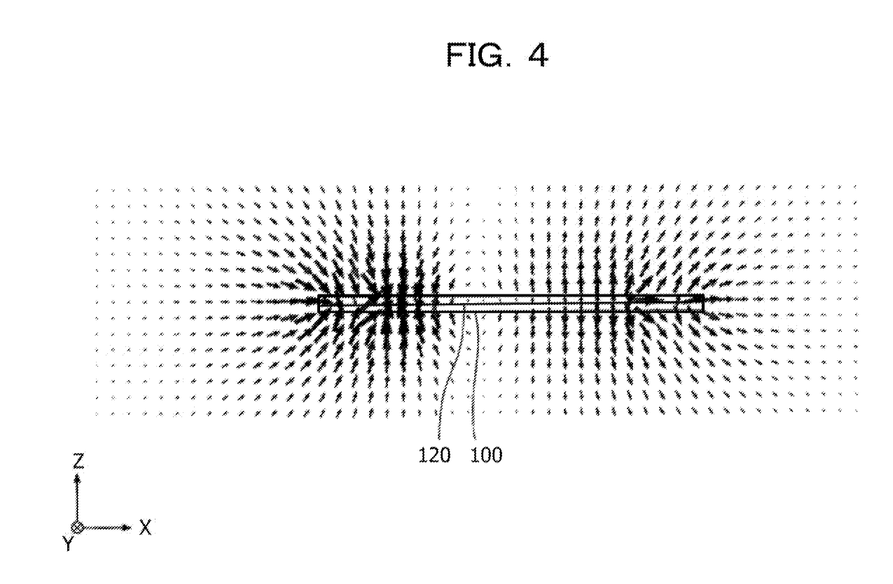

FIG. 4 illustrates simulation results of determining the electric field vectors of the RFID tag 100. In FIG. 4, in the case where the RFID tag 100 is placed in the air, the simulation results of the electric field vectors in the XZ plane are depicted when the Y-axis positive direction side is viewed from the Y-axis negative direction side.

The electric field vectors are indicated with arrows and the size of the arrows indicates the magnitude of the electric field of the electric field vectors. As the arrows of the electric field vector are larger, the electric field is stronger and as the arrows of the electric field vector are smaller, the electric field is weaker.

When as illustrated in FIG. 4, the RFID tag 100 is placed in the air, on the central axis of the RFID tag 100 along the X axis, large electric field vectors toward the X-axis positive direction are obtained further on the X-axis negative direction side than the center of the RFID tag 100 in the X-axis direction. Further, on the central axis of the RFID tag 100 along the X axis, large electric field vectors toward the X-axis positive direction are also obtained further on the X-axis positive direction side than the center of the RFID tag 100 in the X-axis direction.

In other points, on the whole, the electric field vectors that are oriented from the X-axis negative direction side toward the X-axis positive direction side are obtained.

Since the electric field vectors illustrated in FIG. 4 indicate the orientations in the AC electric field at a moment, at the timing when the phase of the AC electric field is different by 180 degrees, on the central axis of the RFID tag 100 along the X axis, an electric field oriented from the X-axis positive direction side toward the X-axis negative direction side is obtained. Such electric field vectors along the X axis correspond to the arrows A and the arrows C in FIG. 3.

As described above, the simulation results illustrated in FIG. 4 demonstrate that the electric field vectors along the X axis are obtainable when the RFID tag 100 is placed in the air.

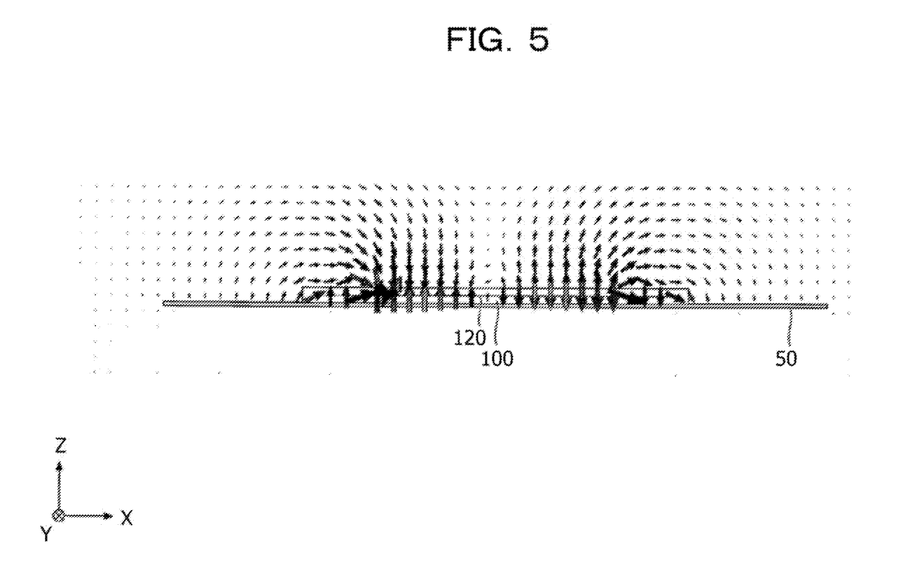

FIG. 5 illustrates simulation results of determining the electric field vectors of the RFID tag 100. In FIG. 5, in the case where the RFID tag 100 is placed on the metal plate 50, the simulation results of the electric field vectors in the XZ plane are depicted when the Y-axis positive direction side is viewed from the Y-axis negative direction side. The metal plate 50 is sufficiently larger than the RFID tag 100 in a plan view.

In FIG. 5, similar to FIG. 4, the electric field vectors are indicated with arrows and the size of the arrows indicates the magnitude of the electric field of the electric field vectors. As the arrows of the electric field vector are larger, the electric field is stronger and as the arrows of the electric field vector are smaller, the electric field is weaker.

As illustrated in FIG. 5, when the RFID tag 100 is placed on the metal plate 50, the electric field vectors that pass through the RFID tag 100 in the Z-axis direction (the thickness direction) are obtained further on the X-axis negative direction side and the X-axis positive direction side than the center of the RFID tag 100 in the X-axis direction. More specifically, on the X-axis negative direction side, the electric field vectors that pass through the RFID tag 100 in the Z-axis positive direction are obtained and on the X-axis positive direction side, the electric field vectors that pass through the RFID tag 100 in the Z-axis negative direction are obtained.

Further, in FIG. 5, on the central axis of the RFID tag 100 along the X axis or near the central axis, few electric field vectors are obtained in the X-axis direction.

Since the electric field vectors illustrated in FIG. 5 indicate the orientations in the AC electric field at a moment, at the timing when the phase of the AC electric field is different by 180 degrees, it is conceivable that the electric field vectors that pass through the RFID tag 100 in the Z-axis negative direction may be obtained on the X-axis negative direction side, and on the X-axis positive direction side, the electric field vectors that pass through the RFID tag 100 in the Z-axis positive direction may be obtained.

As described above, the simulation results illustrated in FIG. 5 demonstrate that when the RFID tag 100 is placed on the metal plate 50, the electric field vectors that pass through the RFID tag 100 in the Z-axis direction are obtained. This implies that the coupling between the antenna 120 and the metal plate 50 is greater than the coupling between the antenna 120 and the parasitic elements 130A and 130B.

That is, when the RFID tag 100 is present in the air without being attached to any object, an operational mode in which the coupling between the antenna 120 and the parasitic elements 130A and 130B is major is obtained. In this case, the antenna 120 causes resonance at the first communication frequency (first resonance frequency).

In contrast, when the RFID tag 100 is placed on the metal plate 50, an operational mode in which the coupling between the antenna 120 and the metal plate 50 is major instead of the coupling between the antenna 120 and the parasitic elements 130A and 130B is obtained. In this case, the antenna 120 causes resonance at second communication frequency (second resonance frequency).

As described above, it is found that the change in the counterpart to which the antenna 120 is coupled causes the operational mode to be switched, depending on whether the RFID tag 100 is present in the air without being attached to any object or is placed on the metal plate 50.

As for the level relation between the first communication frequency (the first resonance frequency) and the second communication frequency (the second resonance frequency), the first communication frequency (the first resonance frequency) may be higher than the second communication frequency (the second resonance frequency), or the second communication frequency (the second resonance frequency) may be higher than the first communication frequency (the first resonance frequency). The level relation between the first communication frequency (the first resonance frequency) and the second communication frequency (the second resonance frequency) depends on the degree of the coupling between the antenna 120 and the parasitic elements 130A and 130B, the dimensions of the antenna 120 and the parasitic elements 130A and 130B, and the like. Thus, the first communication frequency (the first resonance frequency) and the second communication frequency (the second resonance frequency) may be equal to each other.

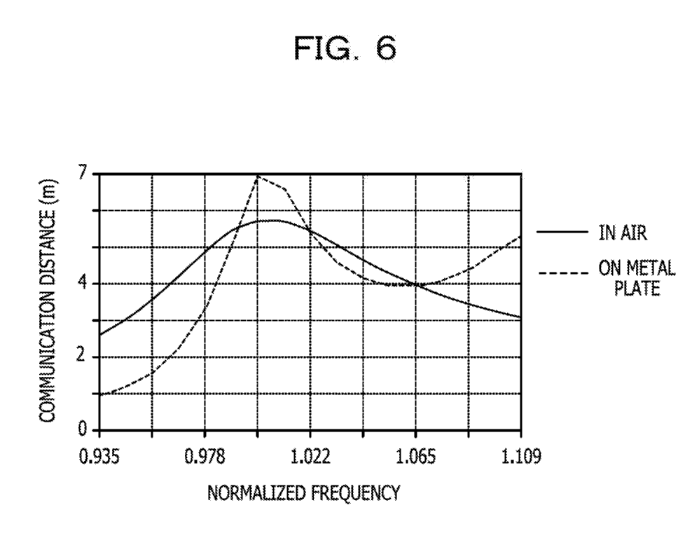

FIG. 6 illustrates the frequency characteristics of the communication distance of the RFID tag 100. In FIG. 6, the horizontal axis indicates the normalized frequency and the vertical axis indicates the communication distance. Since in the design stage of the RFID tag 100, the resonance frequency may be set mainly by changing the length of the antenna 120 in the X-axis direction, FIG. 6 indicates each frequency as the normalized frequency, which is normalized with a value having no measure.

Further, in FIG. 6, the solid line indicates the communication distance in the case where the RFID tag 100 is present in the air and the broken line indicates the communication distance in the case where the RFID tag 100 is placed on the metal plate 50.

As illustrated in FIG. 6, the two frequency characteristics that include three intersection points are obtained, that is, the frequency characteristics of the communication distance in the case where the RFID tag 100 is present in the air and the frequency characteristics of the communication distance in the case where the RFID tag 100 is placed on the metal plate 50.

The two frequency characteristics illustrated in FIG. 6 are obtained by adjusting the dimensions of the antenna 120, the dimensions of the parasitic elements 130A and 130B, the degree of the coupling between the antenna 120 and the parasitic elements 130A and 130B, and the like and are adjusted so that the communication distance and the frequency band have as close values as possible.

When the difference between the communication distance in the case where the RFID tag 100 is present in the air and the communication distance in the case where the RFID tag 100 is placed on the metal plate 50 is within approximately ±20% in a desirable frequency band, even if the RFID tag 100 placed on the metal plate 50 and the RFID tag 100 not placed on the metal plate 50 are both present, both may be read.

That is, it is conceivable that when the difference in the two communication distances is within approximately ±20% in the desirable frequency band, no hindrance may occur in reading the RFID tag 100 using the reader-writer.

According to FIG. 6, when the normalized frequency is in the frequency band from approximately 0.98 to approximately 1.08, the communication distance of 4 m or longer is obtained.

Thus, even if the RFID tag 100 placed on the metal plate 50 and the RFID tag 100 not placed on the metal plate 50 are both present, when each distance from the reader-writer is 4 m or shorter, all the RFID tags 100 may be read.

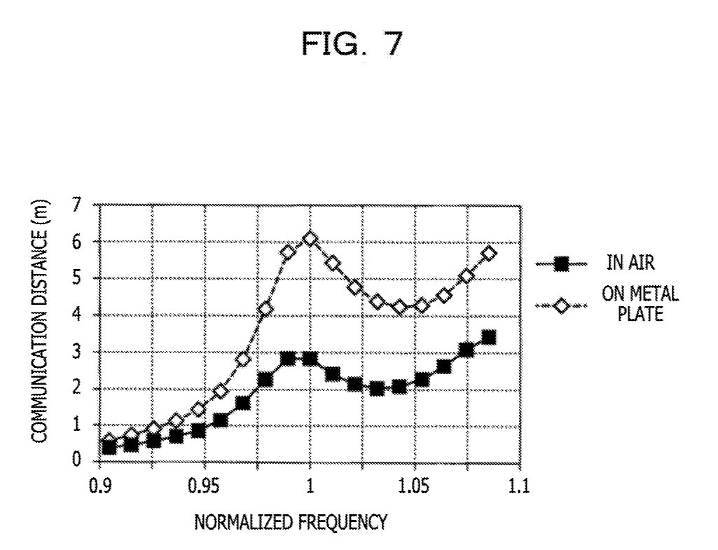

Referring now to FIG. 7, the frequency characteristics of the communication distance of an RFID tag for comparison are described. FIG. 7 illustrates the frequency characteristics of the communication distance of the RFID tag for comparison. In FIG. 7, the horizontal axis indicates the normalized frequency and the vertical axis indicates the communication distance.

The RFID tag for comparison has a structure obtained by removing the parasitic elements 130A and 130B from the RFID tag 100. In FIG. 7, similar to FIG. 6, the solid line indicates the communication distance in the case where the RFID tag for comparison is present in the air and the broken line indicates the communication distance in the case where the RFID tag for comparison is placed on the metal plate 50.

As illustrated in FIG. 7, in all frequency bands, the communication distance of the RFID tag for comparison placed on the metal plate 50 is longer than the communication distance of the RFID tag for comparison not placed on the metal plate 50 and the difference is approximately double. This big difference in the communication distance is caused by large decrease in the communication distance in the case where the RFID tag for comparison is present in the air, compared to the communication distance in the case where the RFID tag 100 is present in the air.

The RFID tag for comparison does not include the parasitic elements 130A and 130B. Thus, when the RFID tag for comparison is present in the air, the resonance of the antenna 120 is singly used for communication. It is conceivable that since singly using the antenna 120 may fail to bring the effect of increasing the apparent area of the antenna 120 as brought in the case of being coupled to the parasitic elements 130A and 130B, no increase in gain may be obtained and the communication distance may decrease accordingly.

In contrast, the frequency characteristics of the communication distance of the RFID tag for comparison placed on the metal plate 50 are similar to those of the communication distance of the RFID tag 100 placed on the metal plate 50 for the reason described below. That is, since when the RFID tag 100 is placed on the metal plate 50, the coupling between the antenna 120 and the parasitic elements 130A and 130B is weakened, even the RFID tag for comparison without the parasitic elements 130A and 130B may achieve the communication distance similar to that achieved by the RFID tag 100.

As described above, the counterpart to which the antenna 120 is coupled is switched, depending on whether the RFID tag 100 is present in the air without being attached to any object or is placed on the metal plate 50. Thus, at desirable communication frequency, even when the RFID tag 100 is placed on the metal plate 50 or is present in the air, a similar communication distance may be obtained by for example, adjusting the degree of the coupling between the parasitic elements 130A and 130B, which are coupled to the antenna 120 when the RFID tag 100 is present in the air, and the antenna 120.

Thus, according to the embodiment, the antenna device 100A, which may enable stable communication, and the RFID tag 100 including the antenna device 100A may be provided.

Although in the description above, as an example, the possibility of reading the RFID tag 100 is determined with reference to the distance from the reader-writer, which is 4 m, the reference is not limited to 4 m. For example, when it is sufficient for the RFID tag 100 to be read in a range of 2 m or 3 m from the reader-writer, a usable frequency band may expand.

Further, in the embodiment described above, the line 122 and the line 123 are formed so as to surround the slot-like non-formation portion 124 provided near the vertex 121 of the antenna 120 on the X-axis negative direction side and the Y-axis positive direction side, and the IC chip 140 is connected to the terminals 122A and 123A at the respective ends of the line 122 and the line 123.

However, the non-formation portion 124 may be formed at a given position in the X-axis direction. In this case, the positions of the terminals 122A and 123A are moved in the X-axis direction, depending on the position of the non-formation portion 124, and the position at which the IC chip 140 is mounted is also moved in the X-axis direction.

Further, although in the embodiment described above, the non-formation portion 124 is positioned in an end portion on the Y-axis positive direction side, the non-formation portion 124 may be positioned in an end portion on the Y-axis negative direction side or may be at a given position between an end portion of the antenna 120 on the Y-axis positive direction side and an end portion of the antenna 120 on the Y-axis negative direction side. When the position of the non-formation portion 124 moves in the Y-axis direction, the positions of the terminals 122A and 123A and the position at which the IC chip 140 is mounted also move in the Y-axis direction.

Further, although in the embodiment described above, the terminals 122A and 123A are provided at the respective ends of the line 122 and the line 123, the antenna 120 may be a rectangular element without the non-formation portion 124 and the terminals 122A and 123A may each be positioned on an edge of the rectangular antenna 120. For another example, the terminals 122A and 123A may each be provided at an end of a line drawn from an edge of the rectangular antenna 120.

Further, although in the embodiment described above, the antenna device 100A (see FIG. 2) is applied to the RFID tag 100, the antenna device 100A is applicable to a device other than the RFID tag 100.

When the antenna device 100A is present in the air without being attached to any object, the operational mode in which the coupling between the antenna 120 and the parasitic elements 130A and 130B is major is obtained.

When the antenna device 100A is placed on the metal plate 50, the operational mode in which the coupling between the antenna 120 and the metal plate 50 is major instead of the coupling between the antenna 120 and the parasitic elements 130A and 130B is obtained.

As described above, in the antenna device 100A, the operational mode is switched, depending on whether the object to which the antenna device 100A is attached is made of metal or no metal. The antenna device 100A may be utilized in an application other than an RFID tag.

Variations of the antenna device 100A or the RFID tag 100 according to the embodiment, and the like are described below.

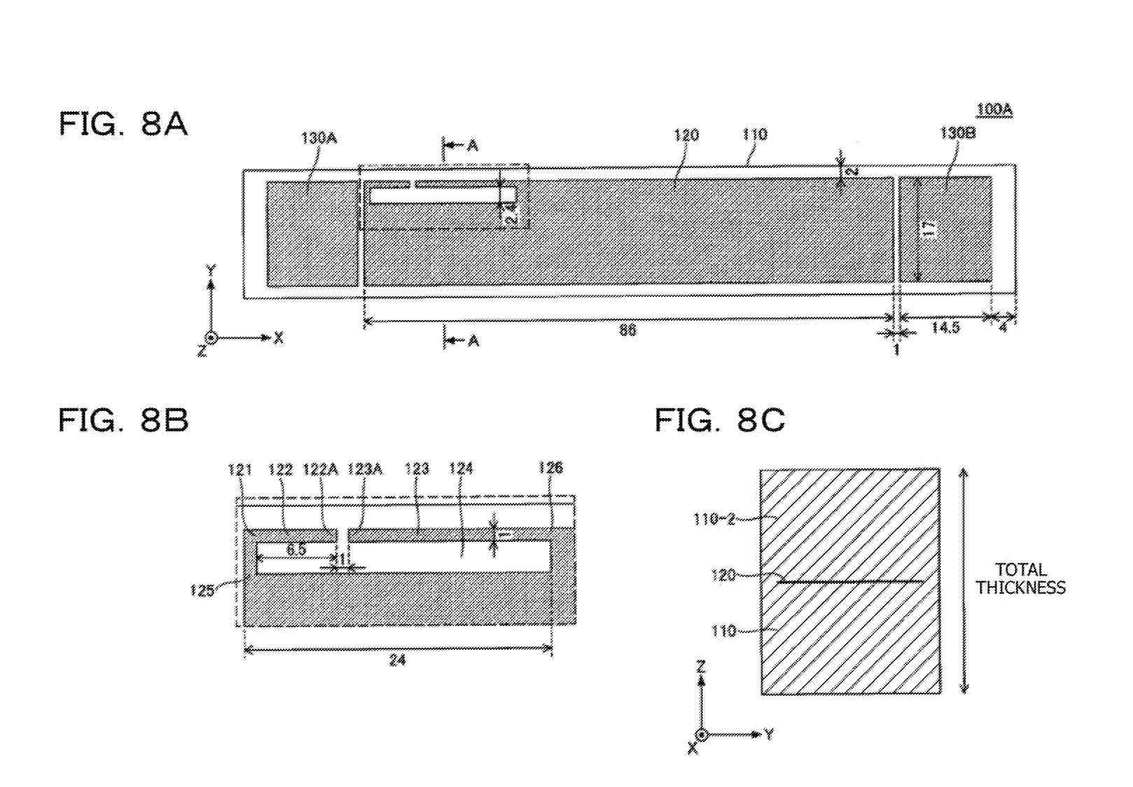

FIGS. 8A to 8C illustrate examples of the dimensions of a simulation model of the antenna device 100A. FIG. 8A illustrates the antenna device 100A in an XY plan view, FIG. 8B illustrates the non-formation portion 124 and the periphery thereof through enlargement, and FIG. 8C illustrates a cross-sectional view based on arrows A in the antenna device 100A in FIG. 8A. The values in FIGS. 8A to 8C are indicated in mm.

As illustrated in FIG. 8A, the length of the antenna 120 in the X-axis direction is 86 mm, the width of the antenna 120 in the Y-axis direction is 17 mm, each length by which the base portion 110 is longer than the antenna 120 in the Y-axis direction is 2 mm. The length of the parasitic element 130A in the X-axis direction is 14.5 mm, the width of the parasitic element 130A in the Y-axis direction is 17 mm, and the length by which the base portion 110 is longer than the parasitic element 130A in the X-axis direction is 4 mm. The clearance between the antenna 120 and the parasitic element 130A in the X-axis direction is 1 mm and the width of the non-formation portion 124 in the Y-axis direction is 2.4 mm.

As illustrated in FIG. 8B, the length of a section of the line 122 in the X-axis direction is 6.5 mm, and each width of the line 122 and the line 123 is 1 mm, the gap between the terminal 122A and the terminal 123A in the X-axis direction is 1 mm, and the length of the non-formation portion 124 in the X-axis direction is 24 mm.

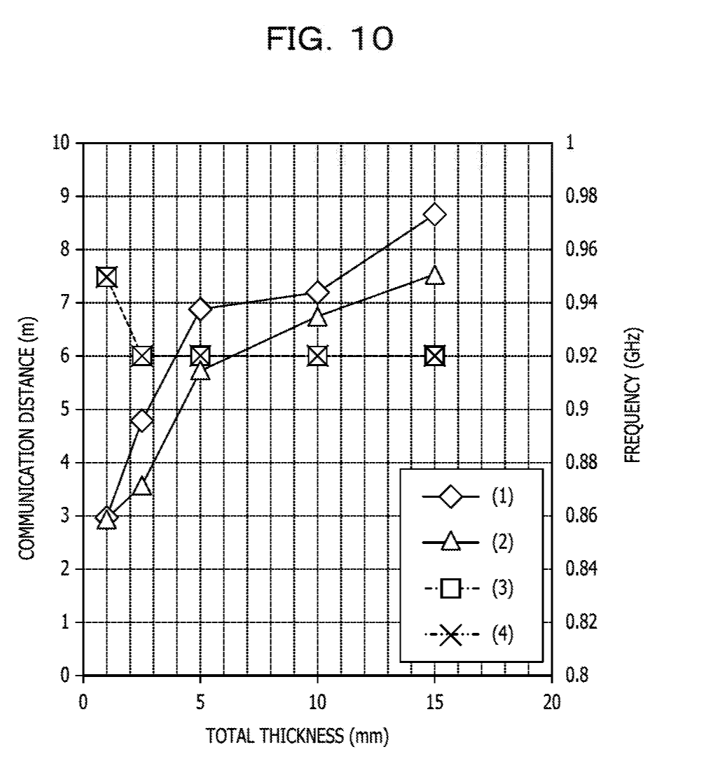

As illustrated in FIG. 8C, in this example, a base portion 110-2 is attached onto the base portion 110 so as to sandwich the antenna 120 and the parasitic elements 130A and 130B. The thicknesses of the base portion 110 and the base portion 110-2 are equal to each other and the entire thickness is denoted as the total thickness. The simulation results obtained when the total thickness is adjusted are described below using FIG. 10.

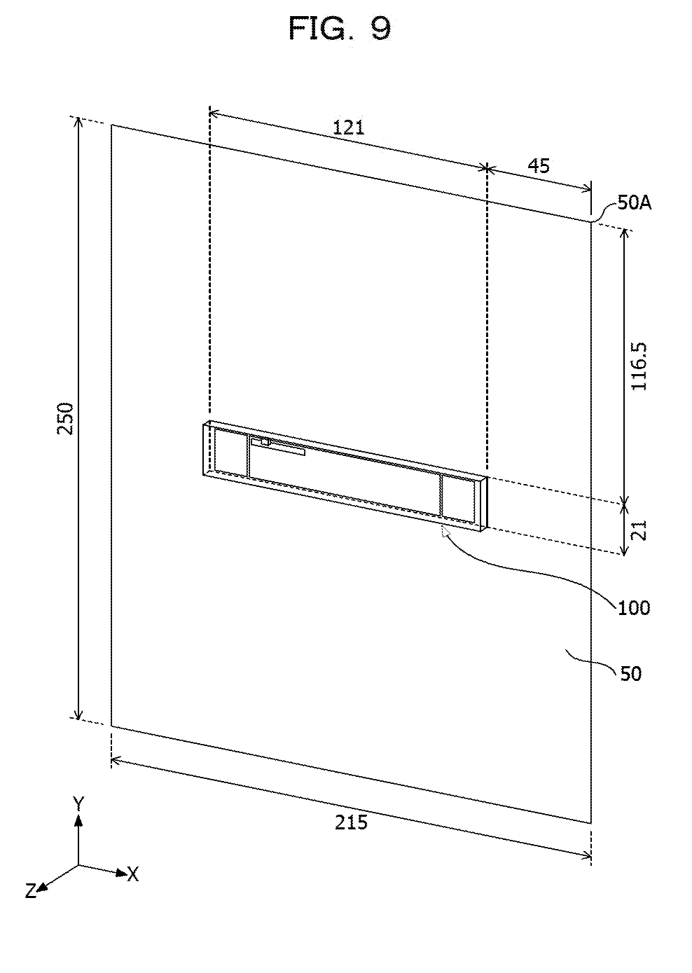

FIG. 9 illustrates examples of the dimensions of a simulation model of the metal plate 50. In FIG. 9, an XYZ coordinate system in common with that in FIGS. 8A to 8C is depicted.

The length of the metal plate 50 in the X-axis direction is 215 mm and the length of the metal plate 50 in the Y-axis direction is 250 mm. The antenna device 100A is arranged on the front surface of the metal plate 50 on the Z-axis positive direction side so that, on the X-axis positive direction side of the metal plate 50, an end portion of the base portion 110 on the X-axis positive direction side is located at a position apart in the X-axis negative direction by 45 mm from a vertex 50A on the Y-axis positive direction side, and an end portion of the base portion 110 on the Y-axis positive direction side is located at a position apart in the Y-axis negative direction by 116.5 mm from the vertex 50A. The length of the base portion 110 in the X-axis direction is 121 mm and the width of the base portion 110 in the Y-axis direction is 21 mm.

FIG. 10 illustrates the characteristics of the antenna device 100A with respect to the communication distance and the total width of the resonance frequency. The simulation results illustrated in FIG. 10 are obtained by changing the total thickness indicated in FIG. 8C when the simulation model of the antenna device 100A is arranged on the simulation model of the metal plate 50 as illustrated in FIG. 9.

Further, FIG. 10 also illustrates the characteristics with respect to the communication distance and the total width of the resonance frequency in the case the simulation model of the antenna device 100A depicted in FIG. 8C is arranged in the air without being attached to any object.

In FIG. 10, characteristics (1) represent the characteristics of the antenna device 100A arranged on the metal plate 50 with respect to the communication distance and the total width. Characteristics (2) represent the characteristics of the antenna device 100A arranged in the air with respect to the communication distance and the total width. Characteristics (3) represent the characteristics of the antenna device 100A arranged on the metal plate 50 with respect to the total width of the resonance frequency. Characteristics (4) represent the characteristics of the antenna device 100A arranged in the air with respect to the total width of the resonance frequency.

The characteristics (1) and the characteristics (2) illustrated in FIG. 10 demonstrate that as the total thickness increases, the communication distance tends to increase. When the total thickness exceeds approximately 3 mm, the communication distance of approximately 4 m or longer is obtained in both the characteristics (1) and the characteristics (2). The difference between the characteristics (1) and the characteristics (2) is within approximately ±20%.

As described above, it is demonstrated that the communication distances of the antenna device 100A arranged on the metal plate 50 and the antenna device 100A arranged in the air are similar to each other.

In addition, the characteristics (1) and the characteristics (2) demonstrate that when the total thickness is between approximately 1 mm and approximately 2.5 mm, as the total thickness increases, the resonance frequency tends to decrease. It is conceivable that this is caused by the effect of the shortening in a wavelength because of the increase in the thicknesses of the base portion 110 and the base portion 110-2, which are dielectrics.

The characteristics (1) and the characteristics (2) also demonstrate that when the total thickness is approximately 2.5 mm or longer, the resonance frequency tends to remain approximately unchanged even when the total thickness increases.

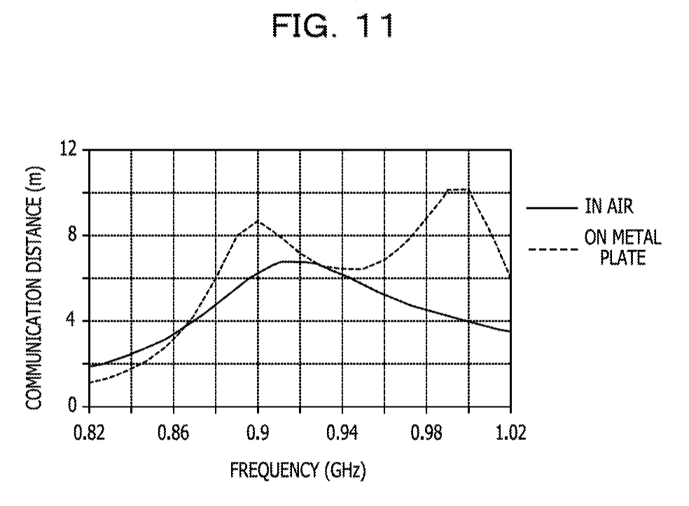

FIG. 11 illustrates the frequency characteristics of the communication distance of the antenna device 100A in a case where the total thickness is set to 10 mm. In FIG. 11, the horizontal axis indicates the normalized frequency and the vertical axis indicates the communication distance. Further, in FIG. 11, the solid line indicates the communication distance in the case where the antenna device 100A is present in the air and the broken line indicates the communication distance in the case where the antenna device 100A is placed on the metal plate 50.

As illustrated in FIG. 11, two frequency characteristics that include two intersection points are obtained, that is, the frequency characteristics of the communication distance in the case where the antenna device 100A is present in the air and the frequency characteristics of the communication distance in the case where the antenna device 100A is placed on the metal plate 50.

The two frequency characteristics illustrated in FIG. 11 are obtained by setting the total thickness of the simulation model illustrated in FIGS. 8A to 8C and FIG. 9 to 10 mm.

In FIG. 11, in the frequency band where the normalized frequency is between approximately 0.82 and approximately 0.95, the difference in the communication distance is within approximately ±20%. Further, in the frequency band where the normalized frequency is between approximately 0.87 and approximately 0.95, the communication distance is 4 m or longer and the difference in the communication distance is within approximately ±20%.

Thus, even if the RFID tag 100 placed on the metal plate 50 and the RFID tag 100 not placed on the metal plate 50 are both present, when each distance from the reader-writer is 4 m or shorter, all the RFID tags 100 may be read.

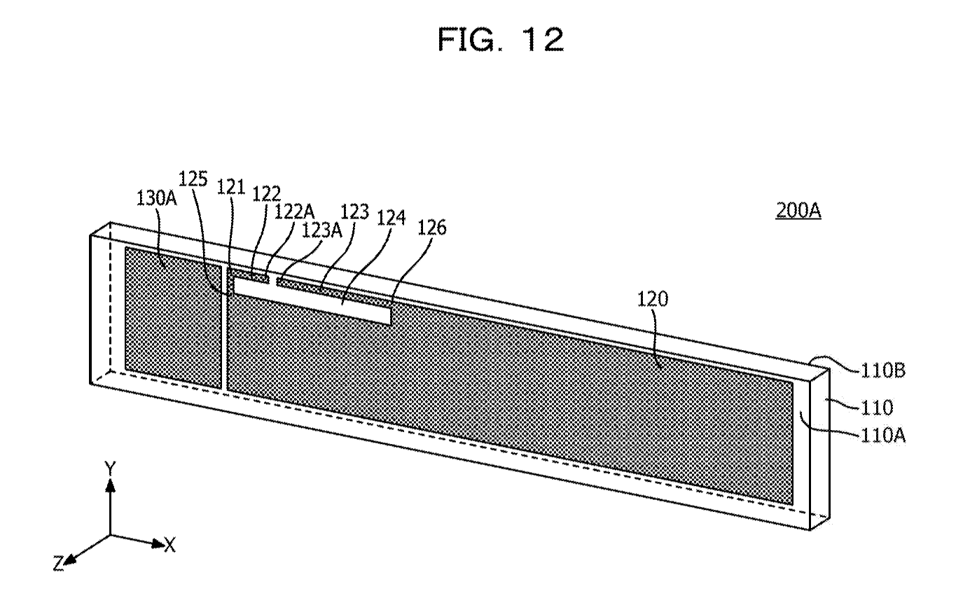

FIG. 12 illustrates an antenna device 200A according to a variation of the embodiment.

The antenna device 200A includes the base portion 110, the antenna 120, and the parasitic element 130A. The antenna device 200A has a structure obtained by removing the parasitic element 130B from the antenna device 100A illustrated in FIG. 2. The other constituents are similar to those of the antenna device 100A illustrated in FIG. 2.

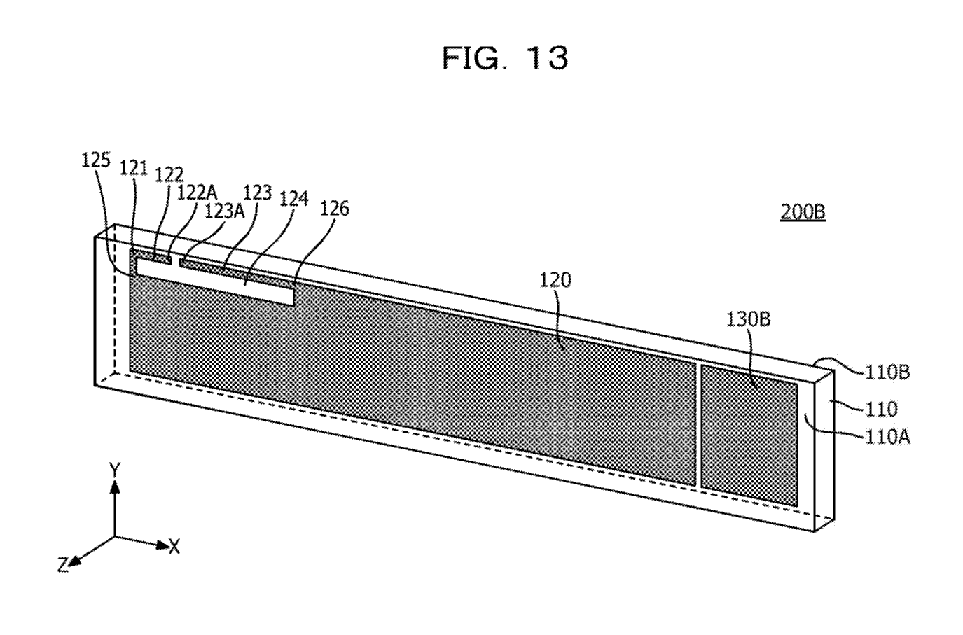

FIG. 13 illustrates an antenna device 200B according to a variation of the embodiment.

The antenna device 200B includes the base portion 110, the antenna 120, and the parasitic element 130B. The antenna device 200B has a structure obtained by removing the parasitic element 130A from the antenna device 100A illustrated in FIG. 2. The other constituents are similar to those of the antenna device 100A illustrated in FIG. 2.

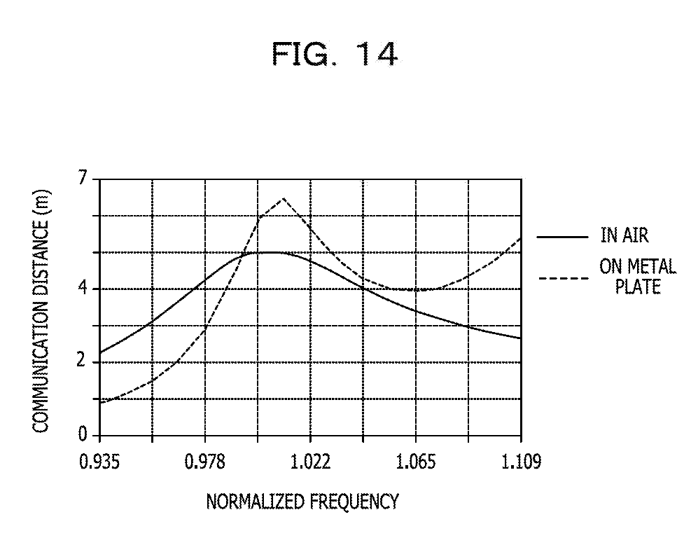

FIG. 14 illustrates the frequency characteristics of the communication distance of the antenna device 200A. In FIG. 14, the horizontal axis indicates the normalized frequency and the vertical axis indicates the communication distance. Further, in FIG. 14, the solid line indicates the communication distance in a case where the antenna device 200A is present in the air and the broken line indicates the communication distance in a case where the antenna device 200A is placed on the metal plate 50.

As illustrated in FIG. 14, two frequency characteristics that include one intersection point are obtained, that is, the frequency characteristics of the communication distance in the case where the antenna device 200A is present in the air and the frequency characteristics of the communication distance in the case where the antenna device 200A is placed on the metal plate 50.

In FIG. 14, in the frequency band where the normalized frequency is between approximately 0.98 and approximately 1.08, the difference in the communication distance is within approximately ±20%. Further, in the frequency band where the normalized frequency is between approximately 0.98 and approximately 1.04, the communication distance is 4 m or longer and the difference in the communication distance is within approximately ±20%. In addition, the maximum value of the communication distance in the case where the antenna device 200A is present in the air is approximately 5 m.

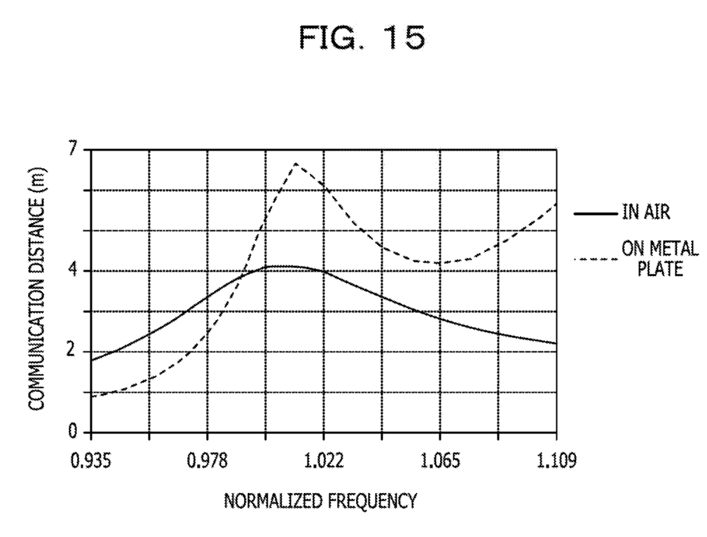

FIG. 15 illustrates the frequency characteristics of the communication distance of the antenna device 200B. In FIG. 15, the horizontal axis indicates the normalized frequency and the vertical axis indicates the communication distance. Further, in FIG. 15, the solid line indicates the communication distance in a case where the antenna device 200B is present in the air and the broken line indicates the communication distance in a case where the antenna device 200B is placed on the metal plate 50.

As illustrated in FIG. 15, two frequency characteristics that include one intersection point is obtained, that is, the frequency characteristics of the communication distance in the case where the antenna device 200B is present in the air and the frequency characteristics of the communication distance in the case where the antenna device 200B is placed on the metal plate 50.

In FIG. 15, compared to FIG. 14, the frequency band where the difference in the communication distance is within approximately ±20% is narrowed and the communication distance is shortened. However, the maximum value of the communication distance in the case where the antenna device 200B is present in the air is approximately 4 m, and the maximum value of the communication distance of an RFID tag that includes the antenna device 200B placed on the metal plate 50 of this example is approximately 6.5 m.

It is conceivable that the communication distance of the antenna device 200B illustrated in FIG. 15 is shortened, compared to the communication distance of the antenna device 200A illustrated in FIG. 14, since the antenna device 200A illustrated in FIG. 12 may include the parasitic element 130A near the terminal 122A and the terminal 123A that serve as feeding points.

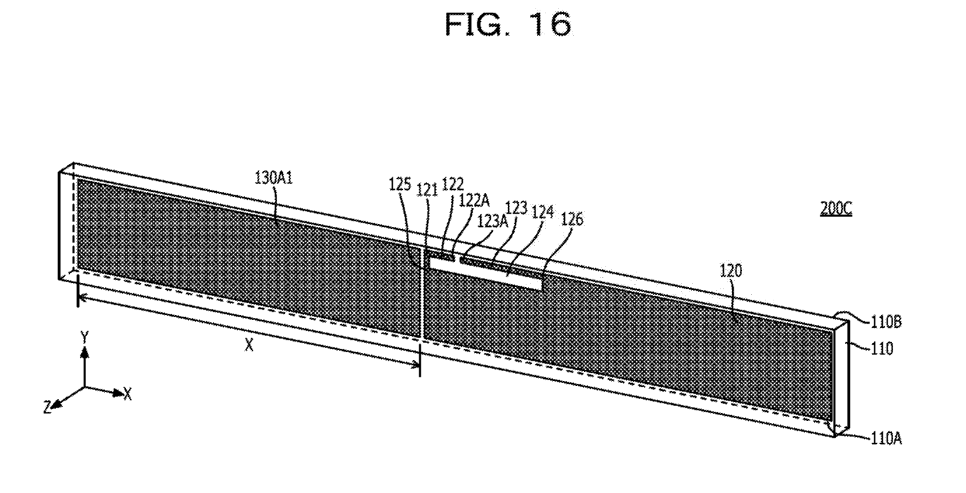

FIG. 16 illustrates an antenna device 200C according to a variation of the embodiment.

The antenna device 200C includes the base portion 110, the antenna 120, and a parasitic element 130A1. The antenna device 200C is a simulation model obtained by removing the parasitic element 130B from the antenna device 100A illustrated in FIG. 2 and replacing the parasitic element 130A with the parasitic element 130A1 whose length in the X-axis direction is X, which is a variable. The other constituents are similar to those of the antenna device 100A illustrated in FIG. 2.

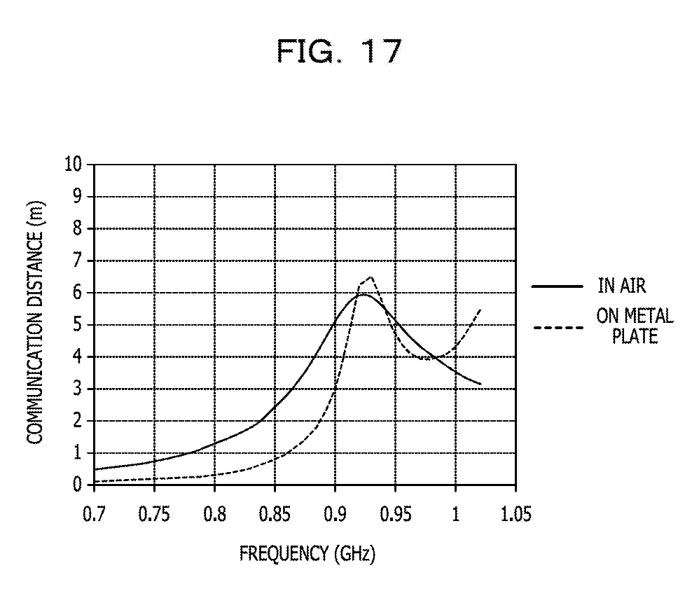

FIG. 17 illustrates the frequency characteristics of the communication distance of the antenna device 200C. In FIG. 17, the horizontal axis indicates the frequency in GHz and the vertical axis indicates the communication distance in m. Further, in FIG. 17, the solid line indicates the communication distance in a case where the antenna device 200C is present in the air and the broken line indicates the communication distance in a case where the antenna device 200C is placed on the metal plate 50.

Through the simulation performed while changing the length X of the parasitic element 130A1 in the X-axis direction, most preferable frequency characteristics are obtained when X=24.333 mm. The results are indicated in FIG. 17.

As illustrated in FIG. 17, two frequency characteristics that include two intersection points are obtained, that is, the frequency characteristics of the communication distance in the case where the antenna device 200C is present in the air and the frequency characteristics of the communication distance in the case where the antenna device 200C is placed on the metal plate 50.

In FIG. 17, in the frequency band where the frequency is between approximately 0.92 GHz and approximately 0.95 GHz, the difference in the communication distance is within approximately ±20% and the communication distance is approximately 5 m or longer.

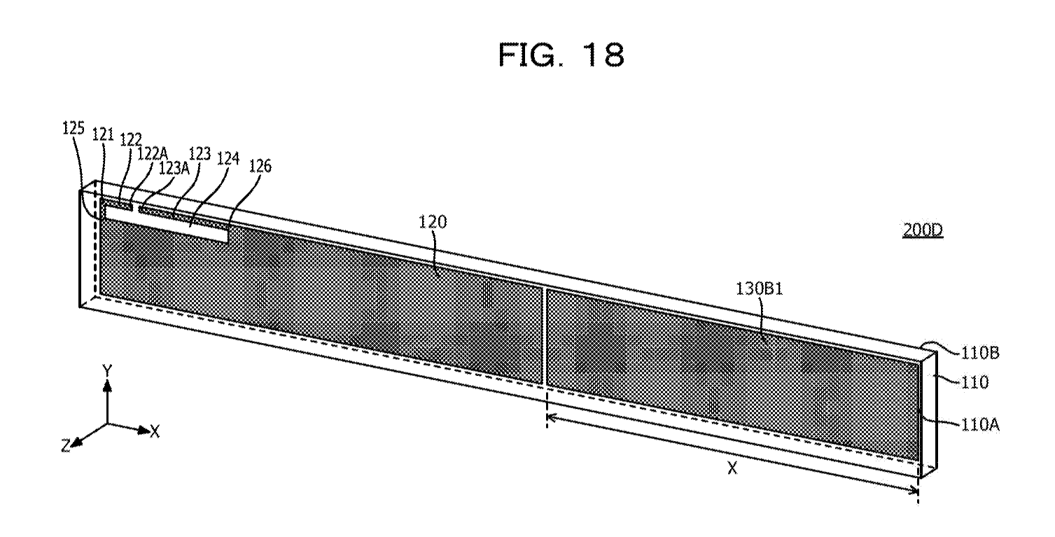

FIG. 18 illustrates an antenna device 200D according to a variation of the embodiment.

The antenna device 200D includes the base portion 110, the antenna 120, and a parasitic element 130B1. The antenna device 200D is a simulation model obtained by removing the parasitic element 130A from the antenna device 100A illustrated in FIG. 2 and replacing the parasitic element 130B with the parasitic element 130B1 whose length in the X-axis direction is X, which is a variable. The other constituents are similar to those of the antenna device 100A illustrated in FIG. 2.

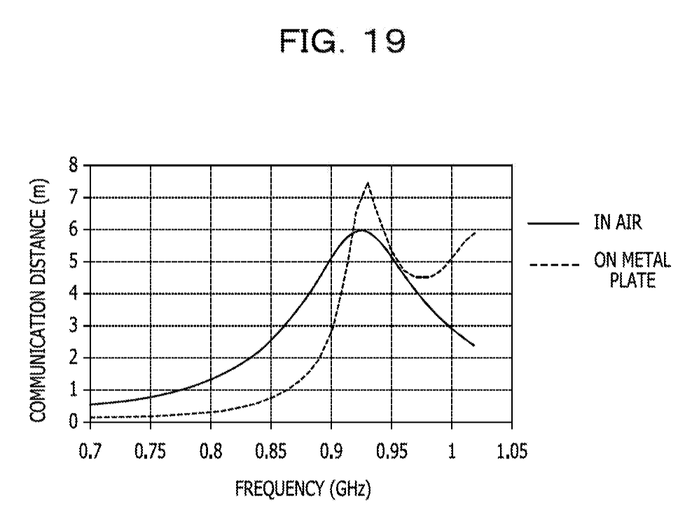

FIG. 19 illustrates the frequency characteristics of the communication distance of the antenna device 200D. In FIG. 19, the horizontal axis indicates the frequency in GHz and the vertical axis indicates the communication distance in m. Further, in FIG. 19, the solid line indicates the communication distance in a case where the antenna device 200D is present in the air and the broken line indicates the communication distance in a case where the antenna device 200D is placed on the metal plate 50.

Through the simulation performed while changing the length X of the parasitic element 130B1 in the X-axis direction, most preferable frequency characteristics are obtained when X=71 mm. The results are indicated in FIG. 19.

As illustrated in FIG. 19, two frequency characteristics that include one intersection point are obtained, that is, the frequency characteristics of the communication distance in the case where the antenna device 200D is present in the air and the frequency characteristics of the communication distance in the case where the antenna device 200D is placed on the metal plate 50.

In FIG. 19, in the frequency band where the frequency is between approximately 0.92 GHz and approximately 0.98 GHz, the difference in the communication distance is within approximately ±20% and the communication distance is approximately 4 m or longer.

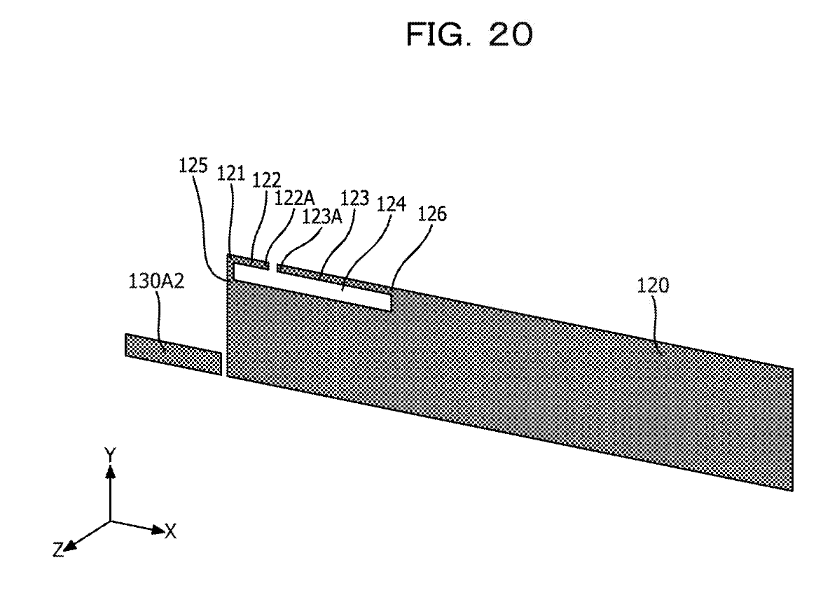

Referring now to FIGS. 20 to 32, variations of the antenna 120 and the parasitic elements 130A and 130B, and the like are described. FIGS. 20 to 23 and FIGS. 25 to 32 illustrate variations of the embodiment.

As illustrated in FIG. 20, a parasitic element 130A2 arranged on the X-axis negative direction side of the antenna 120 may have a width narrower in the Y-axis direction than that of the antenna 120 and an end portion of the parasitic element 130A2 on the Y-axis negative direction side may be arranged so as to accord with an end portion of the antenna 120 on the Y-axis negative direction side.

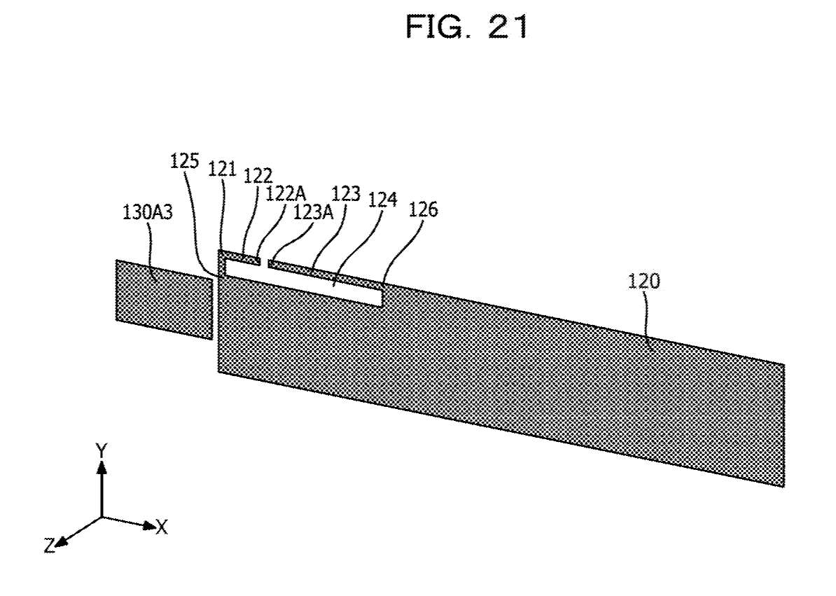

As illustrated in FIG. 21, a parasitic element 130A3 arranged on the X-axis negative direction side of the antenna 120 may have a width narrower in the Y-axis direction than that of the antenna 120 and end portions of the parasitic element 130A3 on the Y-axis positive direction side and the Y-axis negative direction side may be arranged so as to be within the width of the antenna 120 in the Y-axis direction.

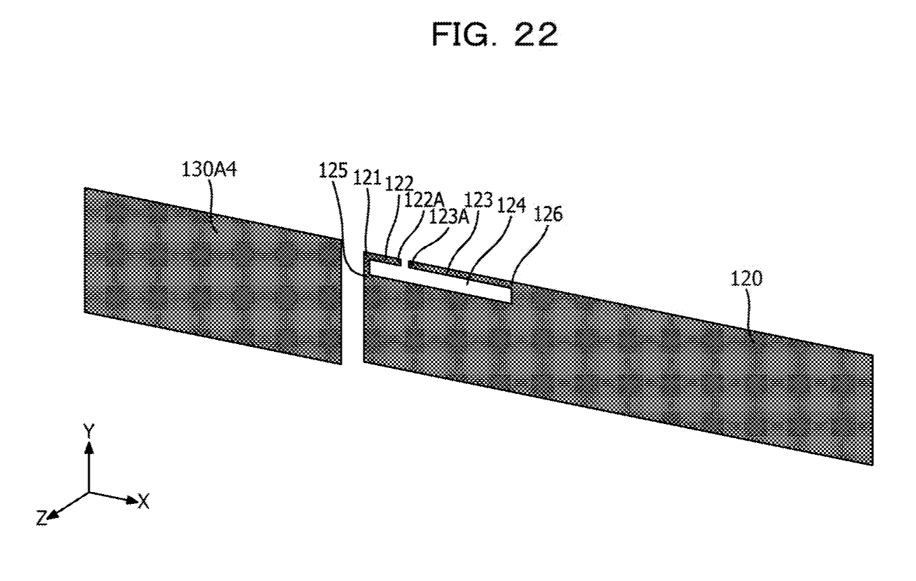

As illustrated in FIG. 22, a parasitic element 130A4 arranged on the X-axis negative direction side of the antenna 120 may have a width wider in the Y-axis direction than that of the antenna 120 and end portions of the parasitic element 130A4 on the Y-axis positive direction side and the Y-axis negative direction side may be arranged so as to be further outside in the Y-axis direction than end portions of the antenna 120 on the Y-axis positive direction side and the Y-axis negative direction side.

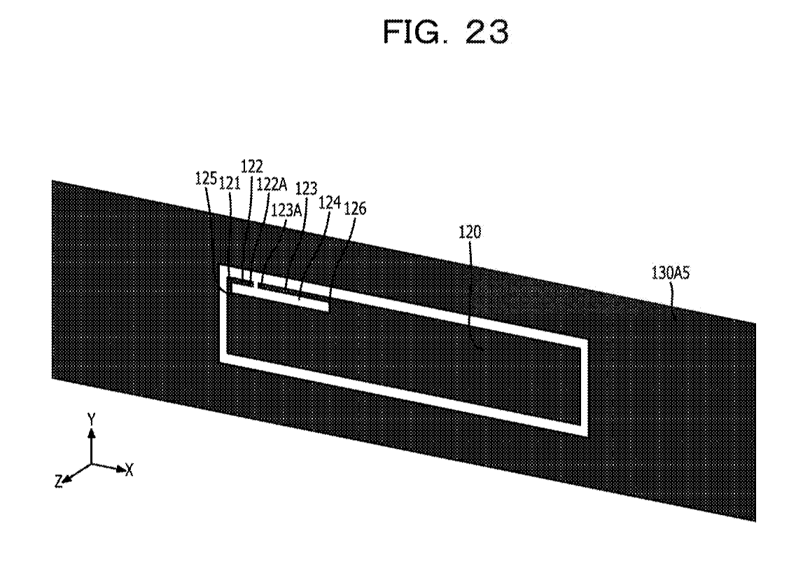

As illustrated in FIG. 23, a parasitic element 130A5 that surround the four sides of the antenna 120 in a plan view may be arranged.

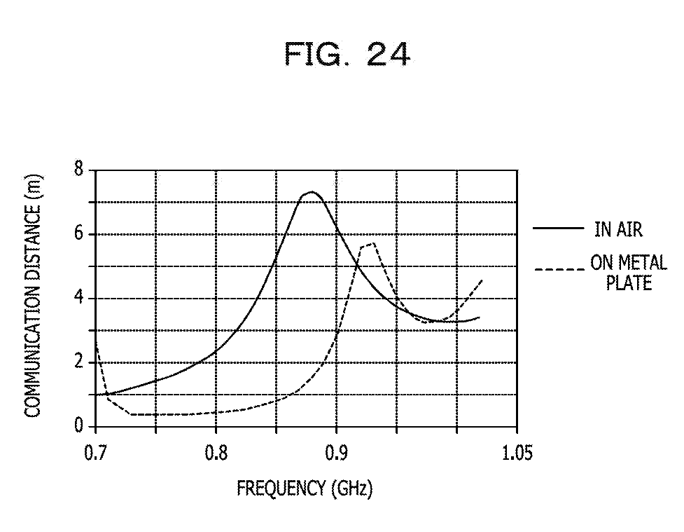

FIG. 24 illustrates the frequency characteristics of the communication distance of an antenna device that uses the antenna 120 and the parasitic element 130A5 illustrated in FIG. 23. In FIG. 24, the horizontal axis indicates the frequency in GHz and the vertical axis indicates the communication distance in m. Further, in FIG. 24, the solid line indicates the communication distance in a case where the antenna device is present in the air and the broken line indicates the communication distance in a case where the antenna device is placed on the metal plate 50.

As illustrated in FIG. 24, in the frequency band where the frequency is between approximately 0.95 GHz and approximately 1.00 GHz, the difference in the communication distance is within approximately ±20% and the communication distance is approximately 3 m or longer.

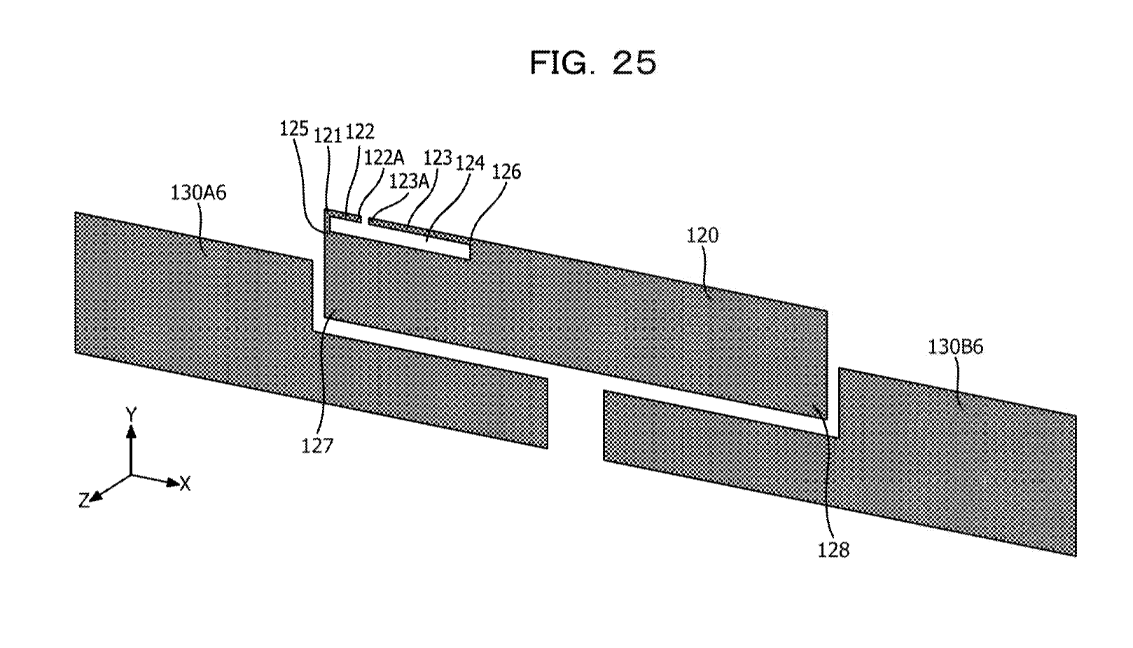

As illustrated in FIG. 25, a parasitic element 130A6 arranged on the X-axis negative direction side of the antenna 120 is shaped like the capital letter L in a plan view and a parasitic element 130B6 arranged on the X-axis positive direction side is shaped like the inverse of the capital letter L in a plan view. The parasitic elements 130A6 and 130B6 are arranged so that the vertices inside the shape like the capital letter L and the shape like the inverse of the capital letter L are fitted in a vertex 127 positioned on the X-axis negative direction side and the Y-axis negative direction side of the antenna 120 and in a vertex 128 positioned on the X-axis positive direction side and the Y-axis negative direction side of the antenna 120, respectively.

End portions of the parasitic elements 130A6 and 130B6 on the Y-axis positive direction side are positioned approximately at the center in the width of the antenna 120 in the Y-axis direction and end portions of the parasitic elements 130A6 and 130B6 on the Y-axis negative direction side are positioned further on the Y-axis negative direction side than an end portion of the antenna 120 on the Y-axis negative direction side.

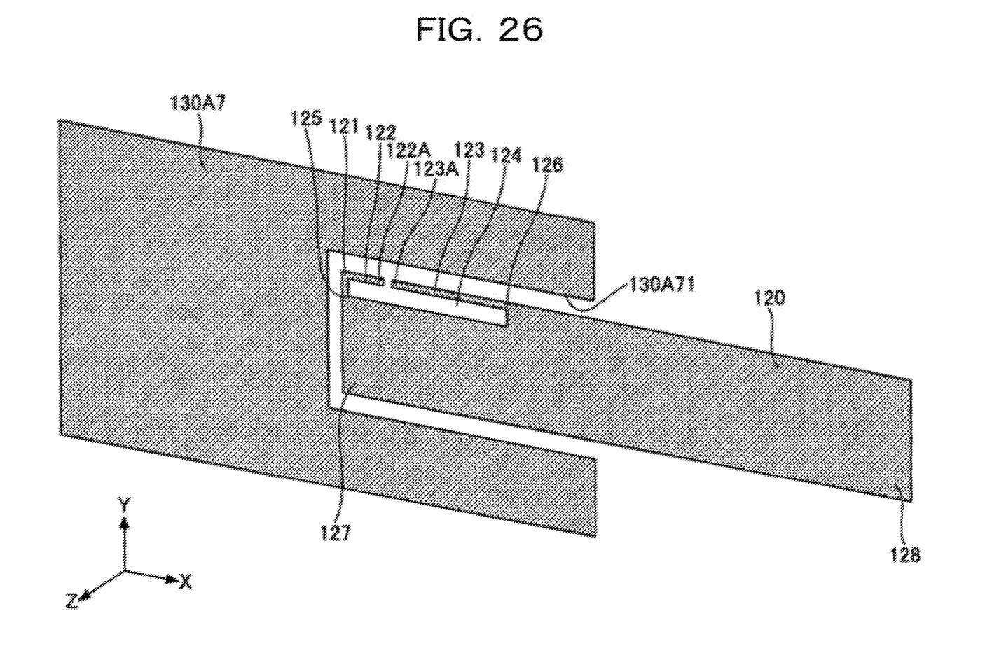

As illustrated in FIG. 26, a parasitic element 130A7 arranged on the X-axis negative direction side of the antenna 120 has a width wider in the Y-axis direction than that of the antenna 120 and includes a depressed portion 130A71 that allows the antenna 120 to be arranged on the X-axis positive direction side. The parasitic element 130A7 is an element shaped like the square-cornered capital letter C, where the depressed portion 130A71 is formed on the X-axis positive direction side of the rectangular pattern.

As illustrated in FIG. 26, the antenna 120 and the parasitic element 130A7 are arranged so that the vertices 121 and 127 of the antenna 120 are positioned deep in the depressed portion 130A71 of the parasitic element 130A7.

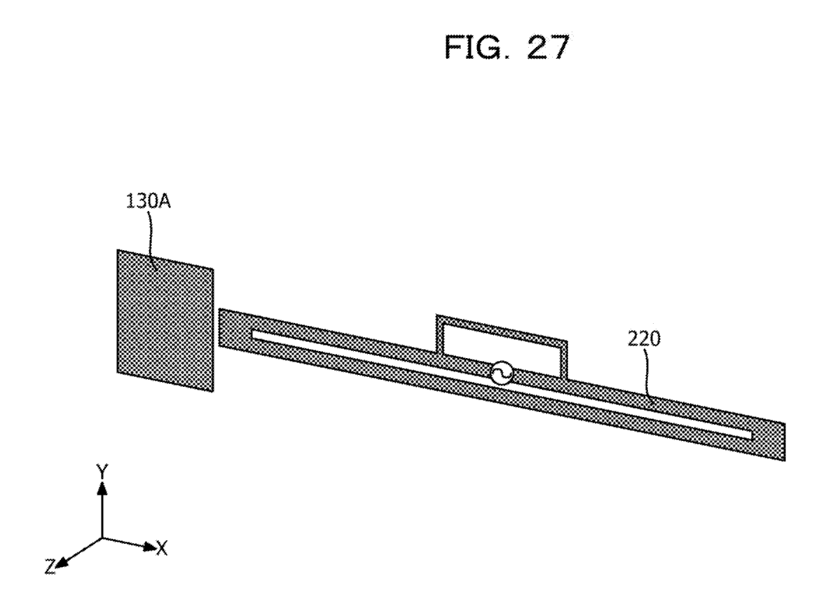

As illustrated in FIG. 27, an antenna 220 is a folded-dipole antenna. In the structure illustrated in FIG. 27, the antenna 220 is arranged instead of the antenna 120 of the antenna device 200A illustrated in FIG. 12.

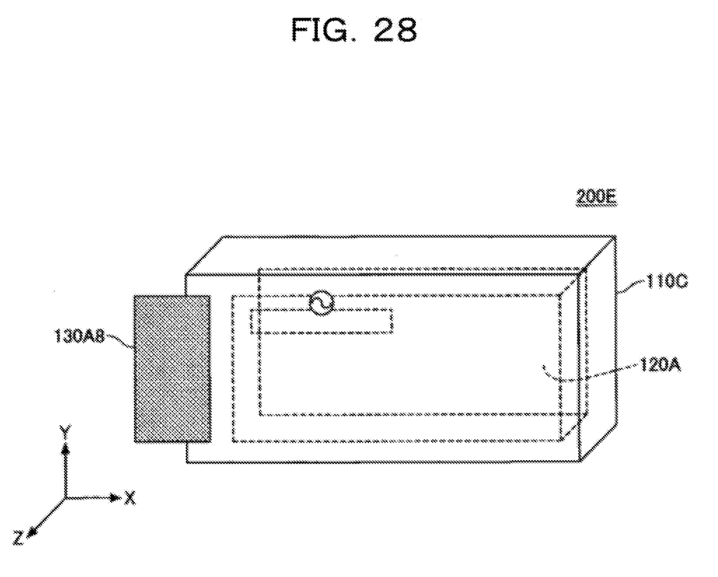

As illustrated in FIG. 28, an antenna 120A folded like the square-cornered capital letter C may be stored in a housing 110C. The antenna 120A is obtained by folding the antenna 120 illustrated in FIGS. 1 and 2 into the shape like the square-cornered capital letter C. The base portion 110 may be present inside the shape like the square-cornered capital letter C. In FIG. 28, a symbol of an AC source is depicted in a portion corresponding to the terminals 122A and 123A illustrated in FIG. 2. The symbol of the AC source indicates the positions of the two feeding points.

A parasitic element 130A8 is attached to the outside of the housing 110C as illustrated in FIG. 28 in a corner portion of the housing 110C on the X-axis negative direction side and the Z-axis positive direction side. The parasitic element 130A8 is similar to the parasitic element 130A illustrated in FIGS. 1 and 2. The X-axis negative direction side of the parasitic element 130A8 projects from the housing 110C toward the X-axis negative direction side.

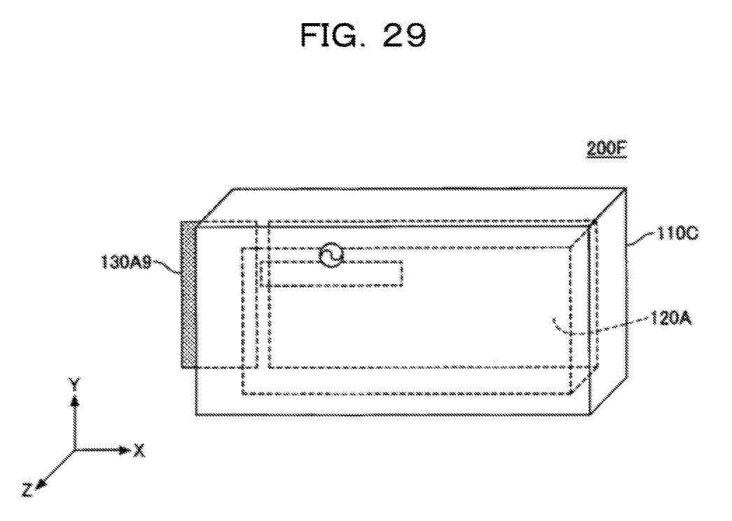

As illustrated in FIG. 29, a parasitic element 130A9 similar to the parasitic element 130A8 may be attached to a corner portion of the housing 110C on the X-axis negative direction side and the Z-axis negative direction side. The symbol of the AC source is similar to that in FIG. 28.

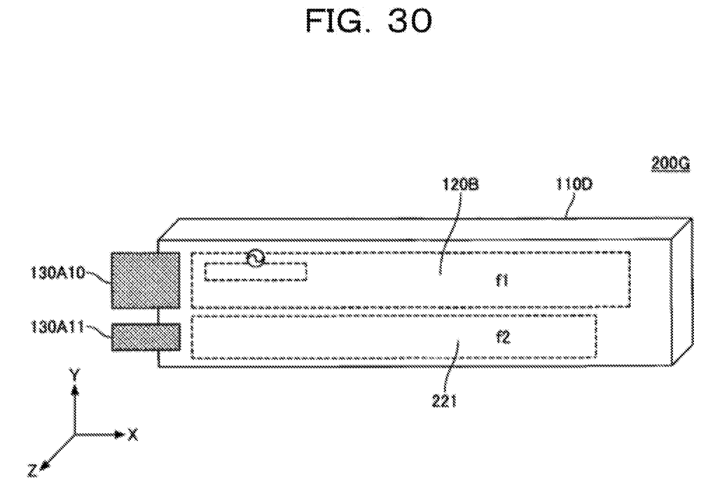

As illustrated in FIG. 30, an antenna 120B and a parasitic element 221 may be stored in a housing 110D, and a parasitic element 130A10 and a parasitic element 130A11, which correspond to the antenna 120B and the parasitic element 221, may be attached to a corner portion of the housing 110D on the X-axis negative direction side and the Z-axis positive direction side.

The antenna 120B is similar to the antenna 120 illustrated in FIGS. 1 and 2. The parasitic element 221 is a parasitic element that is electromagnetically coupled to the antenna 120B, and the resonance frequency of the antenna 120B may be set to f1 while the resonance frequency of the parasitic element 221 may be set to f2. The symbol of the AC source is similar to that in FIG. 28.

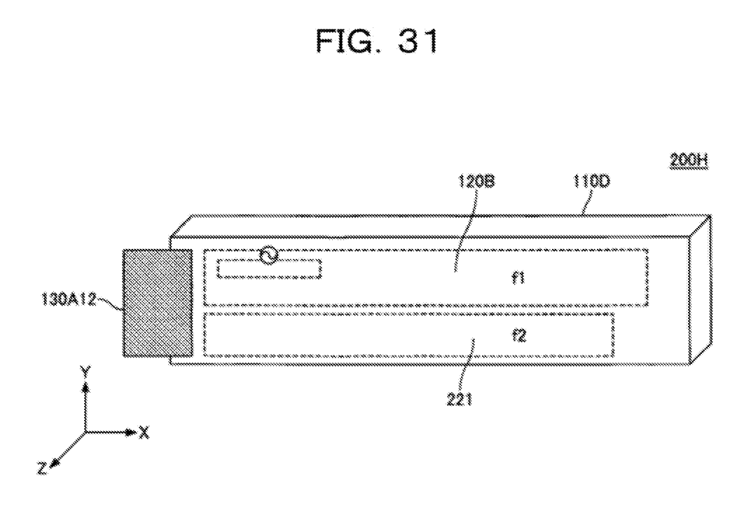

As illustrated in FIG. 31, a parasitic element 130A12, which is obtained by integrating the parasitic elements 130A10 and 130A11 illustrated in FIG. 30, may be attached instead of the parasitic elements 130A10 and 130A11. The symbol of the AC source is similar to that in FIG. 28.

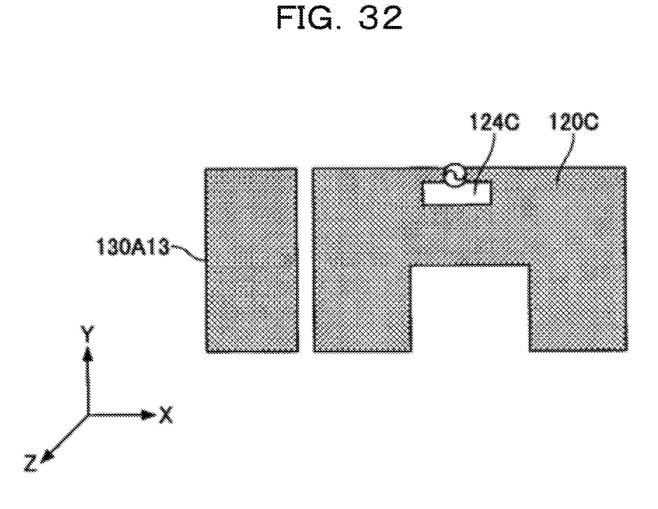

Further, as illustrated in FIG. 32, an antenna 120C shaped like the square-cornered capital letter C in a plan view and a parasitic element 130A13 may be arranged instead of the antenna 120 and the parasitic element 130A illustrated in FIG. 12 so as to be adjacent to each other.

In the antenna 120C illustrated in FIG. 32, a non-formation portion 124C is provided approximately at the center in the X-axis direction. The symbol of the AC source is similar to that in FIG. 28.

Although in FIG. 12, the line 122 and the line 123 are arranged so as to surround the non-formation portion 124 provided near the vertex 121 on the X-axis negative direction side and the Y-axis positive direction side of the antenna 120 and the terminals 122A and 123A are provided at the respective ends of the line 122 and the line 123, the non-formation portion 124C may be provided approximately at the center in the X-axis direction as in the antenna 120C illustrated in FIG. 32.

Although the antenna devices and the RFID tags according to the embodiment of the present application are described above as examples, the present application is not limited to the embodiment disclosed in detail and various changes may be added without deviating from the scope of the aspects of the present application.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An antenna device comprising:
a board including an attachment face for attaching to an object;
a rectangular plane antenna element being disposed in an layer of the board other than the attachment face, including two terminals, and having a longitudinal direction; and
a planar parasitic element being disposed so as to be adjacent to the plane antenna element in the longitudinal direction.

2. The antenna device according to claim 1, wherein the plane antenna element generates an electric field that varies in the longitudinal direction in accordance with alternating current being provided through the two terminals when the object attaching the attachment face is a dielectric or when the attachment face is not attached to the object.

3. The antenna device according to claim 1, wherein
when the object attaching the attachment face is a dielectric or when the attachment face is not attached to the object, the plane antenna element and the parasitic element cause resonance at first resonance frequency, and
when the object attaching the attachment face is a metal, the plane antenna element causes resonance at second resonance frequency different from the first resonance frequency.

4. The antenna device according to claim 3, wherein
an electrical length of the plane antenna element in the longitudinal direction is equal to or shorter than a half wavelength of the first resonance frequency.

5. The antenna device according to claim 1, wherein
the parasitic element includes
a first parasitic element that is adjacent to a side of the plane antenna element in the longitudinal direction on the different face of the board from the attachment face or on the internal layer of the board, and
a second parasitic element that is adjacent to another side of the plane antenna element in the longitudinal direction on the different face of the board from the attachment face or on the internal layer of the board.

6. The antenna device according to claim 1, wherein
degree of coupling between the plane antenna element and the parasitic element is adjusted so that a communication distance in a case where the object to which the board is attached is a dielectric or where the board is not attached to the object and a communication distance in a case where the object to which the board is attached is metal are in a desirable communication band.

7. An RFID tag comprising:
a board including an attachment face for attaching to an object;
a rectangular plane antenna element arraying an layer of the board other than the attachment face, including two terminals, and having a longitudinal direction;
a planar parasitic element arraying so as to be adjacent to the plane antenna element in the longitudinal direction; and
an IC chip including two connectors for coupling to the two terminals arraying an layer of the board other than the attachment face.
